(19) United States
(12) Patent Application Publication
(10) Pub. No.: US 2007/0211452 A1
(43) Pub. Date: Sep. 13, 2007

(54) Illuminated mirror support unit

(76) Inventors: Paul Gaunce, West Bagborough (GB); Rui Can Liang, Nanhai (CN)

Correspondence Address: CARTER, DELUCA, FARRELL & SCHMIDT, LLP, 445 BROAD HOLLOW ROAD, SUITE 225, MELVILLE, NY, 11747, US

(21) Appl. No.: 11/369,392

(22) Filed: Mar. 7, 2006

(51) Int. Cl. F21V 33/00

(52) U.S. Cl. 362/135

(57) ABSTRACT

A wall-mountable mirror support unit including at least one box having a rear face attachable to a wall is provided. A light permeable cover extends over and seals the front of the box to prevent the ingress of water or dirt therein. The box contains at least one light and associated circuitry therein. The support unit includes means to enable a mirror having light-permeable regions to be attached thereto over the front of the box so that the light emitted by each light is transmitted through the light permeable cover and the light permeable regions of the mirror.

### BACKGROUND

1. Technical Field

The present invention relates to a mirror support unit and, in particular, to a mirror support unit provided with an improved water-proof electrical back-lighting section.

2. Background of Related Art

Mirrors units are known in the art that comprise an integral electrical lighting section. Such mirror units generally comprise a rear housing that contains the electrical components such as wiring, a transformer (if present), light bulb(s)/fluorescent tube(s), and a mirror attached over the front of the housing. The mirror is provided with areas where the reflective coating is absent so that the light emitted from the bulb/fluorescent tube can pass therethrough to give the attractive ‘back-lighting’ effect.

Mirror units that are designed to be used in damp environments, such as in bathrooms, are required to meet certain safety standards requiring the housing to be sufficiently sealed to ensure that moisture cannot reach the electrical components therein from the exterior environment. In the UK, this particular safety standard is known as IP44—water or dust proofing—part of electrical lighting British Standards specification EN 60598.

Conventional known bathroom mirror units that meet such safety standards are generally of one of two basic forms of construction:

a) A rear box that houses the electrical components which is secured to a wall and has an open front, and a co-operating front box that fits inside the rear box and has an open rear and a mirror permanently fixed to the front of the front box. A waterproofing seal is provided around the edges of one of the boxes such that when the front box is fitted to the rear box, the seal locates in between the edges of the two boxes to prevent moisture from getting into the interior of the rear box and to the electrical components therein.

b) A single rear box that houses the electrical components, which is secured to a wall and has an open front face. A seal is provided on the rim of the edges of the front of the box, and a mirror is secured over the open front of the box, the rear of the mirror engaging with the seal to prevent moisture from getting into the box and to the electrical components therein.

The two types of mirror unit construction mentioned above have a number of disadvantages. Both comprise at least one box unit of substantially the same size as the mirror itself. These box units are bulky and heavy and can also be expensive to manufacture, adding a significant cost to the final price of the unit. It can also be difficult to line up the seal around the entire perimeter of the box(es) and/or mirror, so making the necessary waterproofing difficult to achieve.

In addition to the above, in both constructions, the moisture-resistant seal is only made waterproof when the mirror is put in place—either when attached to a front box as in construction a) or, when the rear face of the mirror contacts the front edge seal of the rear box as in construction b). This means that the effectiveness of the seal is dependent upon final assembly of the mirror unit once it is in situ, and therefore cannot be controlled by the producer at the manufacturing stage to ensure it is effective. It also means that as soon as the mirror is detached from the unit, the device is no longer electrically safe in such damp environments.

It is therefore an object of the present invention to provide a mirror support unit that substantially alleviates-or overcomes the problems mentioned above.

### SUMMARY

According to the present invention, therefore, there is provided a wall-mountable mirror support unit including at least one box having a rear face attachable to a wall and a light permeable cover extending over and sealing the front of the box to prevent the ingress of water or dirt therein, the box containing at least one light and associated circuitry therein, the support unit including means to enable a mirror having light-permeable regions to be attached thereto over the front of the box so that the light emitted by the or each light is transmitted through the light permeable cover and the light permeable regions of the mirror.

The wall-mountable mirror support unit preferably comprises two boxes and the two boxes are preferably jointed to one another by a connecting plate.

In a preferred embodiment, the two boxes are elongate and orientated parallel to one another, and the connecting plate is disposed between the boxes to form a generally ‘H’ shape.

The two boxes or each box is preferably formed from a generally ‘U’ shaped extrusion having a rear wall and two side walls. The two boxes or each extruded box is preferably formed with opposing recessed channels in the inside surface of each side wall, distal from the rear wall.

In a preferred embodiment, the light permeable cover or each light permeable cover that comprises the front face of the two boxes or each box is a transparent or translucent plate that is held in position by opposite parallel edges of the plate locating in said recessed channels.

It will be appreciated by those skilled in the art that the precise shape of the box or boxes described above and the means by which the light permeable cover is attached over the front of the box or boxes is only a preferred embodiment and the invention is not limited to such a preferred embodiment, but rather other shapes of boxes and means of attaching a light permeable cover of the front thereof are intended to fall within the scope of the claims of the invention.

The plate or each plate can conveniently be slid into position in the recessed channels of the two boxes or each box from one end thereof, and the plate or each plate may be made from glass or alternatively may be made from plastic, such as perspex.

Preferably, a sealing material is provided in the recessed channels so that when the plate or each plate is located with its edges in the channels, the sealing material is disposed between the plate edges and the channel to form a waterproof seal therebetween.

Advantageously, the plate or each plate is retained in position in the front face of the two boxes or each box by an end cap fixed to each end of the two boxes or each box, and the end caps are preferably held in position by screws extending into the two boxes or each box.

In a preferred embodiment, the end caps form a watertight seal with the end of the two boxes or each box and the plate or each plate held therein, and a gasket, possibly made of silicon or of rubber, may be disposed between the end-cap or each end-cap and the respective box to create the watertight seal therebetween.

The plate or each plate that forms the light-permeable cover of the two boxes or each box is preferably removable from the two boxes or each box to allow access to the interior thereof.

The light of the two boxes or each box may comprise at least one filament-light bulb held in a socket, and preferably comprises a plurality of filament-light bulbs held in sockets. Alternatively, the light of the two boxes or each box may comprise a fluorescent tube held in an associated socket.

A preferred embodiment of the invention further comprises a mirror mounted over the front of the mirror support unit, the mirror preferably having a rear surface with a reflective coating thereon, and light permeable regions of the mirror are regions where said reflective coating is absent.

The light-permeable regions of the mirror are conveniently positioned to correspond to the position of the light or each light in the two boxes or each box when the mirror is mounted in position over the front of the two boxes or each box. The light-permeable regions are preferably sanded.

In an alternative embodiment, an at least partially transparent or translucent decorative panel may be mounted over the front of the mirror support unit. The decorative panel preferably includes a decorative picture or image thereon. The transparent or translucent portions of the decorative panel may be positioned to correspond to the position of the light or each light in the two boxes or each box when the decorative panel is mounted in position over the front of the two boxes or each box.

In a preferred embodiment, the connecting plate has at least one aperture therein, and the mirror/decorative panel has at least one hook on the rear surface thereof. The at least one hook is receivable in the at least one aperture to enable the mirror/decorative panel to be mounted to and in front of the connecting plate and associated boxes. Conveniently, the connecting plate has a raised portion and the at least one aperture is formed in said raised portion.

The two boxes or each box, exclusive of the front face, is preferably made from metal, and the metal is conveniently aluminium.

### BRIEF DESCRIPTION OF THE DRAWINGS

An embodiment of the present invention will now be described, by way of example only, with reference to FIGS. 5-8, in which:

FIG. 1 is a front perspective view of a first prior art mirror unit;

FIG. 2 is a rear perspective view of the mirror unit of FIG. 1;

FIG. 3 is a front perspective view of a second prior art mirror unit;

FIG. 4 is a rear perspective view of the mirror unit of FIG. 3;

FIG. 5 is a front view of a mirror support unit according to the present invention;

FIG. 6 is a front perspective view of the mirror support unit of FIG. 5 with a mirror proximate the front thereof;

FIG. 7 is a rear perspective view of the mirror support unit and mirror of FIG. 6; and

FIG. 8 is a cross-sectional view of one stanchion of the mirror support unit of FIGS. 5-7.

### DETAILED DESCRIPTION OF EMBODIMENTS

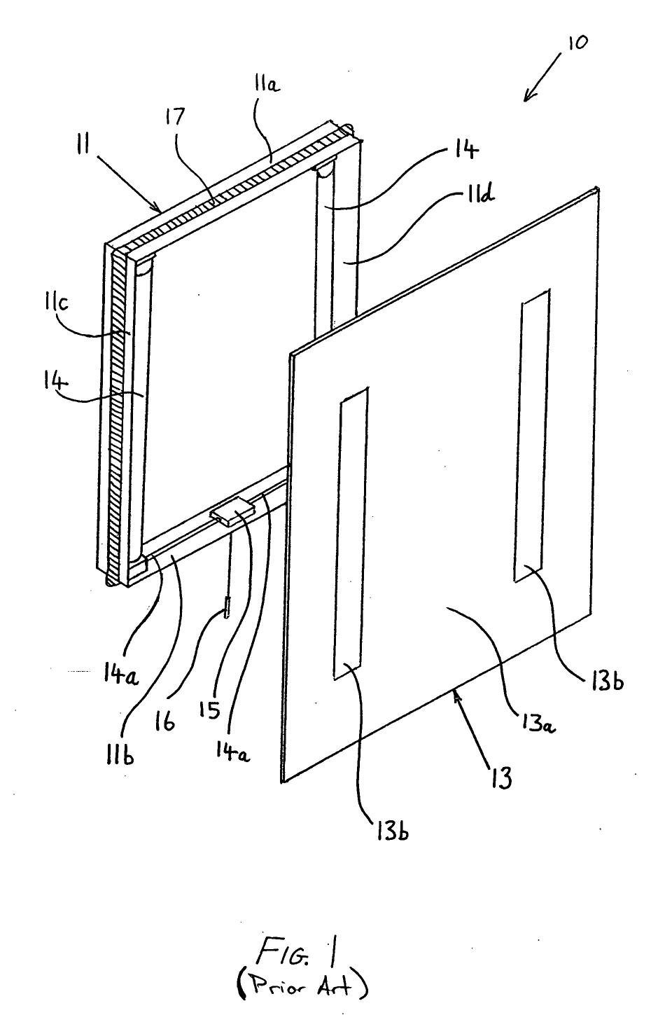

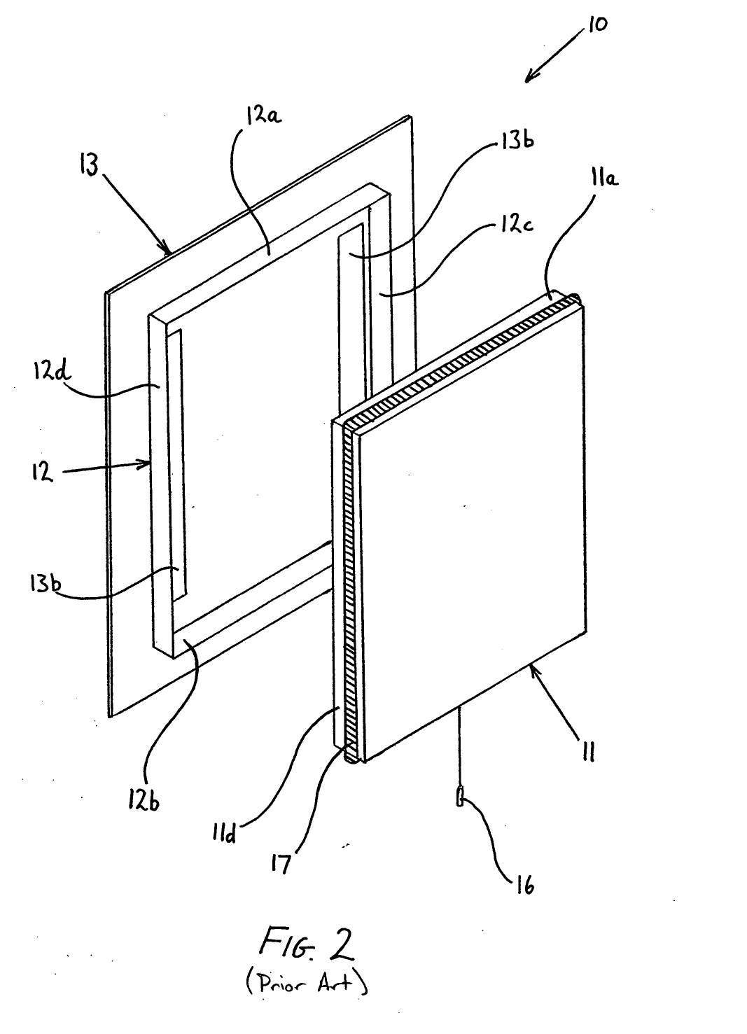

Referring now to FIGS. 1 and 2, a first known embodiment of a mirror unit 10 is disclosed comprising a first box portion 11 having top, bottom, left and right side walls 11a, 11b, 11c, 11d, respectively, and it is open at its front face. The first box 11 contains two fluorescent light tubes 14 electrically connected to a supply of electricity (not shown) by wires 14a, the light tubes 14 being turned on and off by means of a switch 15, which is activated by a pull-toggle 16. A silicon seal 17 extends continuously around the outside surfaces of walls 11a-11d of the first box 11.

A second box portion 12 is open at its rear and has a mirror 13 attached to a front face thereof. The second box 12 includes top, bottom, left and right side walls 12a, 12b, 12c, 12d, respectively. The surface of the mirror 13 has reflective portions 13a which reflect light incident thereon and do not allow light to pass therethrough, and transparent/translucent portions 13b which allow light to pass through from behind the mirror 13 to the front thereof.

In use, the first box portion 11 is mounted to a wall by any suitable fixing means, e.g. screws (not shown) and the wires 14a are connected to a source of electricity (not shown). The mirror unit is then assembled by fitting the second box 12 and associated mirror 13 over the first box 11, and the seal 17 locates between the outside surfaces of the walls 11a-11d of the first box 11, and the inside surfaces of the walls 12a-12d of the second box 12.

Once in the above assembled state, the transparent/translucent portions 13b of the mirror align with the fluorescent light tubes 14 such that when switched on, the light from the light tubes 14 passes through the transparent/translucent portions 13b.

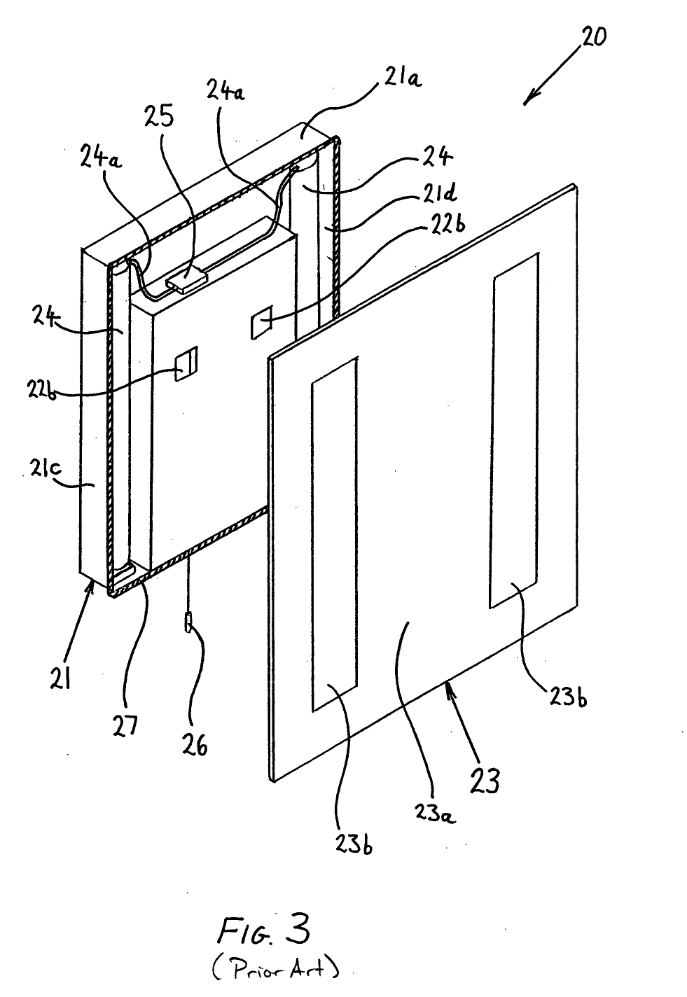

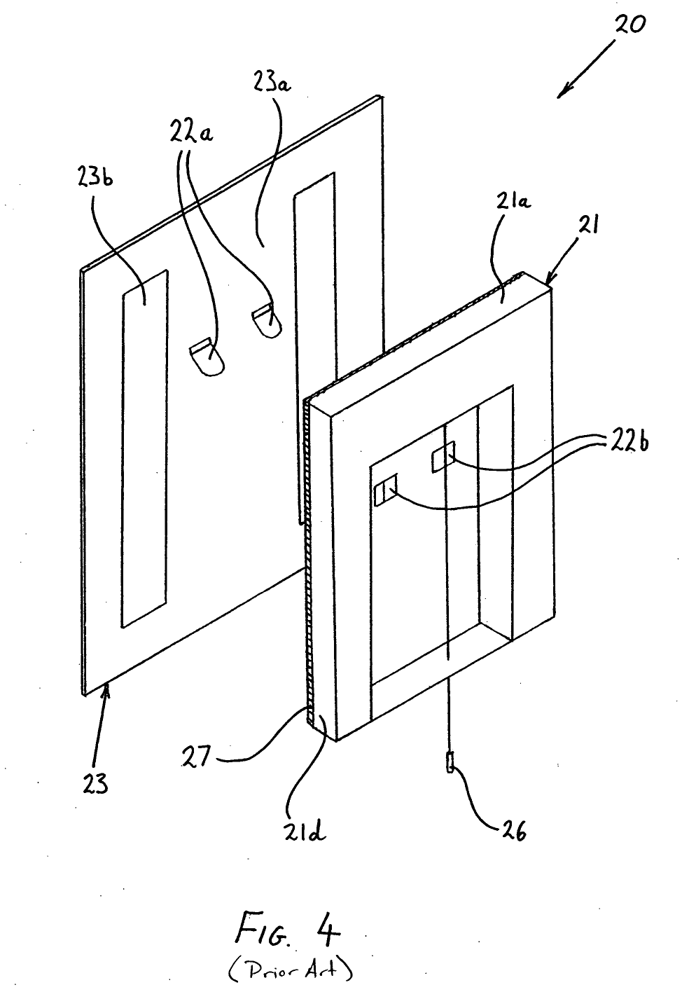

Referring now to FIGS. 3 and 4, a second known embodiment of a mirror unit 20 is disclosed, comprising a box portion 21 having top, bottom, left and right side walls 21a, 21b, 21c, 21d, respectively, and it is open at its front face. The box 21 contains two fluorescent light tubes 24 electrically connected to a supply of electricity (not shown) by wires 24a, the light tubes 24 being turned on and off by means of a switch 25, which is activated by a pull-toggle 26. A silicon seal 27 extends continuously around the front-most lip of each of the walls 21a-21d of the box 21.

A mirror 23 has a surface comprising reflective portions 23a which reflect light incident thereon and do not allow light to pass therethrough, and transparent/translucent portions 23b which allow light to pass through from behind the mirror 23 to the front thereof. In use, the mirror 23 is attached to the box 21 by means of hooks 22a on the rear face 23c of the mirror which engage with corresponding holes 22b on the rear face of the box 21. Once in position, the rear face 23c of the mirror 23 abuts the silicon seal 27 and presses firmly thereagainst to provide a watertight seal operable to prevent moisture reaching the electrical components within the box 21. In this position, the transparent/translucent portions 23b of the mirror align with the fluorescent light tubes 24 such that when switched on, the light from the light tubes 24 passes through the transparent/translucent portions 23b.

As mentioned above, both of the known mirror units include at least one box portion which is heavy and bulky. These box portions are also expensive to manufacture and so add significantly to the overall cost of producing such units. In addition, both of the known types of mirror units require the unit to be fully assembled with the mirror itself in place in order for the waterproof seal to be intact, and so a producer of such units cannot sell them in a pre-waterproofed condition satisfying the necessary safety standards, because the mirror is only fitted to the unit once the unit is installed in its final location, e.g. in a bathroom. An effective waterproof seal can also be difficult to achieve in practice by using a silicon strip as described above, due to the strip becoming damaged in transit or in assembly of the unit, or it coming away from the edge wall(s) of the box portion to which it is attached.

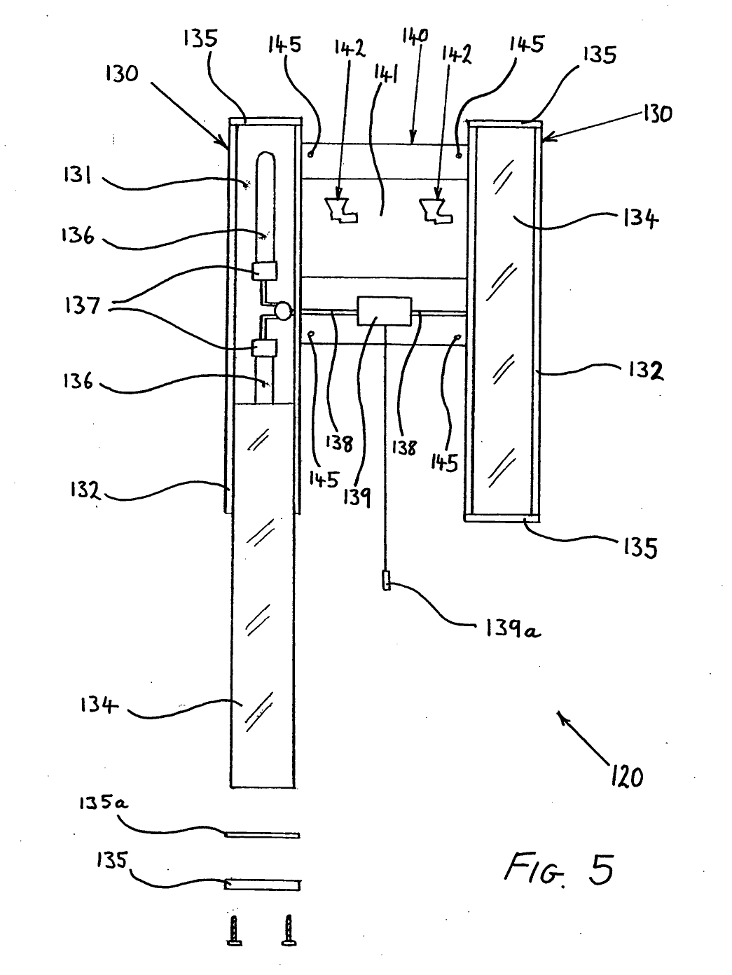

In order to overcome the above-mentioned problems, a mirror support unit 120 of the present invention is provided, and will now be described with reference to FIGS. 5 to 8.

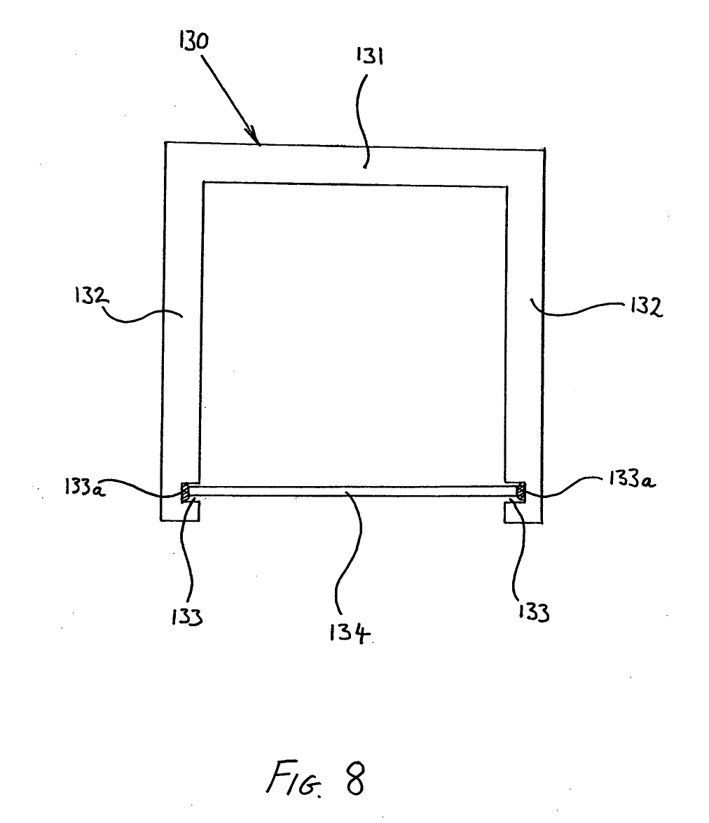

The mirror support unit 120 is generally in the form of an ‘H’ and comprises two spaced parallel vertical stanchions 130 connected to one another by a central backing plate 140. Each stanchion 130 is formed from an extrusion that is generally ‘U’-shaped in cross-section (see FIG. 8), and has a rear wall 131 and side walls 132. A rebate channel 133 is formed in the inside of each side wall 132, distal from the rear wall 131 and extending along the length of the stanchion 130, and positioned such that the rebate channels 133 in each side wall 132 face each other.

A transparent or translucent light permeable plate 134, made from glass or perspex for example, is fitted in the front of each stanchion 130 to close the open side of the ‘U’-shape, and is held in position by the edges of the plate 134 locating in the rebate channels 133. The plate 134 can be located into this position by sliding it in from one end of the stanchion 130 with the panel 134 edges in the rebate channels 133, until the each end of the plate 134 is flush with the respective end of the stanchion 130.

The plates 134 are prevented from sliding out of the stanchions 130 by end caps 135 which are secured to each end of each stanchion 130 by known means—e.g. by screws in the illustrated embodiment which engage with a corresponding aperture (not shown) formed in the extruded stanchion 130. In order to ensure that each stanchion 130 is waterproof, a sealing strip 133a made from a suitable material such as silicon, is provided in each rebate channel 133 (see FIG. 8) so that when the plate 134 is slid into position, the edges of the plate 134 press against the seal strips 133a. Furthermore, a sealing gasket 135a, made from rubber or another such suitable material, is disposed between each end cap 135 and the respective ends of the rear and side walls 131, 132 of each stanchion 130, and the plate 134, to make a watertight seal therebetween. It will be appreciated that each stanchion 130 is individually waterproofed independently of the other.

Each stanchion 130 houses at least one electrical lighting device. These can be either fluorescent tubes, or conventional electrical bulbs. The illustrated embodiment shows each stanchion 130 housing two conventional light bulbs 136 held in sockets 137 that are secured to the rear wall 131. Each socket 137 is connected to a source of electricity (not shown) by conductive wires 138 that extend through a side wall 132 of each stanchion 130. Each wire 138 is connected to the source of electricity via a switch 139, operable to turn the light bulbs 136 on and off by pulling a toggle cord 139a. Although a toggle cord 139a operated switch 139 is illustrated, the invention is not limited to such a switch, and any conventional switch means may be used.

The switch 139 is attached to the backing plate 140 located between the two stanchions 130. The backing plate 140 incorporates a raised section 141 with two apertures 142 therein which are used to mount the mirror 110 to the support unit 120. Each aperture 142 is in the shape of an up-side down trapezium 143 with a further rectangular aperture 144 extending from the bottom right corner of the trapezium and lightly lower than it. The backing plate also includes mounting holes 145 therethrough to allow the mirror support unit 120 to be secured to a wall by conventional means, e.g. screws.

It should be noted that the end caps 135 and sealing gasket 135a can be detached from each end of each stanchion 130. This allows the plate 134 to be slid out of the stanchion 130 along the rebate channels 133 to allow access to the interior of the stanchion 130. This is important for when a user needs to change a light bulb 136 or fluorescent tube. Once the light bulb 136 has been replaced, the plate 136, gasket 135a and end cap 135 can be fitted back in place on the respective end of the stanchion 130 to restore the watertight seal.

In use, the mirror support unit 120 is fixed to a wall or other vertical surface by screws through the mounting holes 145. The wires 138 of the support unit 120 are then connected to a source of electricity (not shown). The mirror support unit 120 is intended to be supplied fully assembled—that is, the plate 134 located in the rebate channels 133 against the seals 133a, and the end caps 135 and gaskets 135a secured over each end of each stanchion 130 so that each stanchion 130 is fully sealed and waterproof to meet British Standards specification EN 60598-IP44.

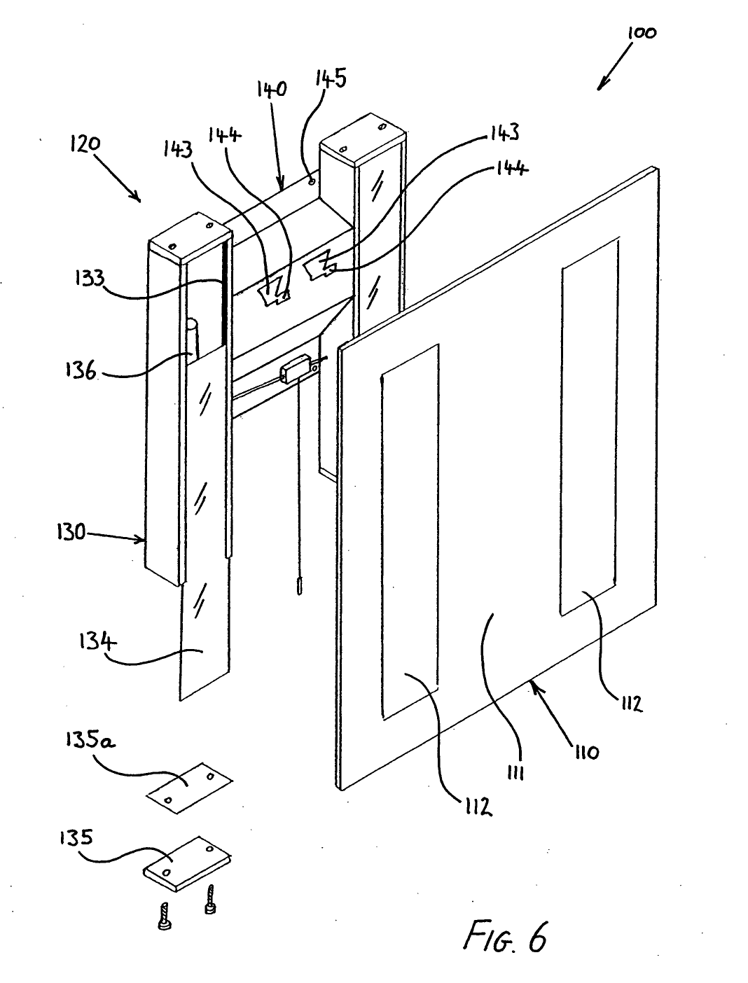

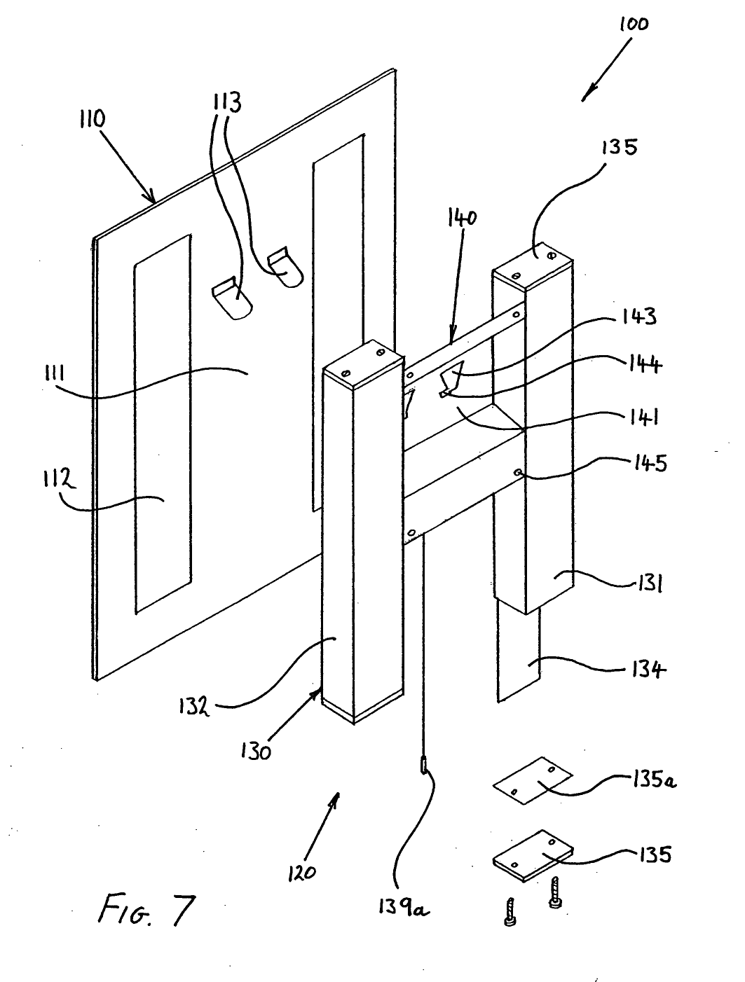

The mirror support unit 120 is designed to be used in conjunction with a mirror 110 (see FIGS. 6 and 7), an example of which will now be described. The mirror 110 comprises a reflective surface 111 over the majority of the surface area, but has areas 112 where the reflective coating has been removed. These areas 112 can either be transparent (e.g. comprise clear glass) or translucent (e.g. the glass in these areas 112 is frosted or sanded). The non-reflective areas 112 are located proximate the side edges of the mirror 110 such that when the mirror 110 is attached to the mirror support unit 120, to form a complete assembled mirror unit 100, the non-reflective areas 112 are positioned over the light bulbs 136. The rear surface of the mirror 110 includes two hooks 113 bonded thereto extending downwards and away from the rear surface of the mirror 110.

Once the mirror support unit 120 is in place, the mirror 110 can be fitted to it. This is done by positioning the mirror 110 such that the hooks 113 on the rear of the mirror 110 can be inserted into the trapezium part 143 of the aperture 142 in the raised portion 141 of the backing plate 140, and as the mirror 110 is lowered, the hooks 113 are guided towards the narrow part of the trapezium-shape hole 143 by its taper, and then the whole mirror 110 is moved to the right and down slightly so that the hooks 113 locate in the rectangular portion 144 of the aperture 142. Once in this final position, the mirror 110 is centrally located and laterally secure, and the non-reflective portions 112 are aligned with the lights 136 in each stanchion 130. The complete mirror unit 100 is now fully assembled.

The above means of attaching a mirror 110 to the mirror support unit 120 is a preferred embodiment only, and any suitable mechanism can be used within the scope of the invention. The mirror 110 could also be glued to the mirror support unit 120.

The complete mirror unit 100 is operated by pulling the toggle cord 139a which operates the switch 139 to turn the lights 136 on or off. When the lights 136 are on, the light emitted therefrom passes through the non-reflective portions 112 of the mirror 110 and produce a ‘back-lighting’ effect.

The mirror support unit 120 of the present invention does not suffer from any of the disadvantages of the known mirror units mentioned above. It is much lighter and more compact than the large boxes of known devices, and because the stanchions 130 are extruded and the back plate 140 can be made from a pressed sheet of metal, the whole mirror support unit 120 is much cheaper to manufacture than known mirror units.

Furthermore, in use, a mirror 110 can easily be removed and replaced with an alternative design if so desired, without affecting the waterproof seal of the mirror support unit 120 behind the mirror 110. Similarly, if the mirror 110 should get broken for any reason, it is simple to replace, and in the intervening period before a new mirror is installed, the exposed mirror support unit 120 is still electrically safe, as the waterproof seal is independent of any mirror 110 and whether or not the whole mirror unit 100 is assembled.

Conversely, to change the mirror 13/23 of any of the prior art mirror units 10/20 would involve the complication of having to break the waterproof seal 17/27 and then having to re-seal the unit 10/20 once the replacement mirror is installed, which is troublesome and presents the risk that the replacement seal may not be correctly fitted, leaving the unit 10/20 at risk of exposure to moisture and the associated dangerous consequences.

It is intended that the present invention may also be used to support a decorative panel instead of a mirror. For example, a translucent panel, made from coloured glass or plastic, could be attached over the front of the mirror support unit 120, and have a decorative pattern or artistic image thereon. Then, when the lights 136 are switched on, the light(s) would illuminate the coloured pattern or image producing an attractive effect.

What is claimed is:

1. A wall-mountable mirror support unit comprising:
at least one box having a rear face attachable to a wall;
a light permeable cover extending over and sealing a front of the box to prevent the ingress of water or dirt therein, each box containing at least one light and associated circuitry therein; and
means to enable a mirror, having light-permeable regions, to be attached thereto over the front of each box so that the light emitted by each light is transmitted through the light permeable cover and the light permeable regions of the mirror.

2. A wall-mountable mirror support unit according to claim 1, further comprising two boxes.

3. A wall-mountable mirror support unit according to claim 2, wherein the two boxes are jointed to one another by a connecting plate.

4. A wall-mountable mirror support unit according to claim 3, wherein the two boxes are elongate and orientated parallel to one another, and the connecting plate is disposed between the two boxes to define a generally ‘H’ shape support unit.

5. A wall-mountable mirror support unit according to claim 1, wherein each box is formed from a generally ‘U’ shaped extrusion having a rear wall and two side walls.

6. A wall-mountable mirror support unit according to claim 5, wherein each extruded box is formed with opposing recessed channels in an inside surface of each side wall, distal from the rear wall.

7. A wall-mountable mirror support unit according to claim 6, wherein each light permeable cover that comprises the front face of each box is at least one of a transparent and a translucent plate that is held in position by opposite parallel edges of the plate locating in said recessed channels.

8. A wall-mountable mirror support unit according to claim 7, wherein each plate is slidable into position in the recessed channels of each box from one end thereof.

9. A wall-mountable mirror support unit according to claim 7, wherein each plate is made from at least one of glass and plastic.

10. A wall-mountable mirror support unit according to claim 7, wherein each plate is made from perspex.

11. A wall-mountable mirror support unit according to claim 7, wherein a sealing material is provided in the recessed channels so that when each plate is located with its edges in the channels, the sealing material is disposed between the plate edges and the channel to form a waterproof seal therebetween.

12. A wall-mountable mirror support unit according to claim 7, wherein each plate is retained in position in the front face of each box by an end cap fixed to each end of each respective box.

13. A wall-mountable mirror support unit according to claim 12, wherein the end caps are held in position by screws extending into each respective box.

14. A wall-mountable mirror support unit according to claim 12, wherein the end caps form a watertight seal with the end of each respective box and each respective plate held therein.

15. A wall-mountable mirror support unit according to claim 14, wherein a gasket is disposed between each end-cap and the respective box to create the watertight seal therebetween.

16. A wall-mountable mirror support unit according to claim 15, wherein the gasket is made from at least one of a silicon and a rubber.

17. A wall-mountable mirror support unit according to claim 7, wherein each plate that forms the light-permeable cover of each box is removable therefrom to allow access to the interior thereof and thereby to each light therein.

18. A wall-mountable mirror support unit according to claim 1, wherein the light of each box comprises at least one filament-light bulb held in a socket.

19. A wall-mountable mirror support unit according to claim 18, wherein the light comprises a plurality of filament-light bulbs held in sockets.

20. A wall-mountable mirror support unit according to claim 1, wherein the light of each box comprises a fluorescent tube held in an associated socket.

21. A wall-mountable mirror support unit according to claim 1, further comprising a mirror mounted over the front of the mirror support unit.

22. A wall-mountable mirror support unit according to claim 21, wherein the mirror has a rear surface with a reflective coating thereon, and light permeable regions including regions of the mirror where said reflective coating is absent.

23. A wall-mountable mirror support unit according to claim 22, wherein the light-permeable regions of the mirror are positioned to correspond to the position of a respective light in each box when the mirror is mounted in position over the front of each box.

24. A wall-mountable mirror support unit according to claim 22, wherein the light-permeable regions are sanded.

25. A wall-mountable mirror support unit according to claim 1, further comprising an at least partially transparent or translucent decorative panel mounted over the front of the mirror support unit.

26. A wall-mountable mirror support unit according to claim 25, wherein the decorative panel includes at least one of a decorative picture and image thereon.

27. A wall-mountable mirror support unit according to claim 25, wherein the transparent or translucent portions of the decorative panel are positioned to correspond to the position of a respective light in each box when the decorative panel is mounted in position over the front of each respective box.

28. A wall-mountable mirror support unit according to claim 21, wherein the connecting plate has at least one aperture therein, and at least one of the mirror and decorative panel has at least one hook on a rear surface thereof, the at least one hook being receivable in the at least one aperture to enable the at least one of the mirror and the decorative panel to be mounted to and in front of the connecting plate and associated boxes.

29. A wall-mountable mirror support unit according to claim 28, wherein the connecting plate has a raised portion and the at least one aperture is formed in said raised portion.

30. A wall-mountable mirror support unit according to claim 1, wherein each box, exclusive of the front face, is made from metal.

31. A wall-mountable mirror support unit according to claim 30, wherein the metal is aluminium.
